(19) United States
(12) Patent Application Publication
(10) Pub. No.: US 2014/0310606 A1
(43) Pub. Date: Oct. 16, 2014

(54) METHOD AND DEVICE FOR PROVIDING PLUGIN IN CONTACT LIST

(71) Applicant: XIAOMI INC., BEIJING (CN)

(72) Inventors: YUXIANG LIU, BEIJING (CN); KUN NIU, BEIJING (CN); ZHONGLIANG QIAO, BEIJING (CN)

(73) Assignee: XIAOMI INC., BEIJING (CN)

(21) Appl. No.: 14/156,756

(22) Filed: Jan. 16, 2014

Related U.S. Application Data
(63) Continuation of application No. PCT/CN2013/085883, filed on Oct. 24, 2013.

(30) Foreign Application Priority Data
Apr. 11, 2013 (CN) 201310125562.4

(51) Int. Cl. G06F 3/0484

(52) U.S. Cl. CPC G06F 3/0484
USPC 715/738

(57) ABSTRACT

A method for a device to provide a plugin in a contact list, wherein the contact list includes an open interface, and the plugin is generated based on a specification defined according to the open interface. The method includes receiving a first request for installing the plugin, and performing an authentication of the plugin according to the first request; adding the plugin into the contact list after the authentication succeeds; and receiving a second request for invoking a function of the plugin, and invoking the function of the plugin according to the second request.

### CROSS REFERENCE TO RELATED APPLICATIONS

The present application is a continuation of International Application No. PCT/CN2013/085883, filed Oct. 24, 2013, which is based upon and claims priority to Chinese Patent Application No. 201310125562.4, filed Apr. 11, 2013, the entire contents of all of which are incorporated herein by reference.

### TECHNICAL FIELD

The present disclosure generally relates to the technical field of communication devices and, more particularly, to a method and a device for providing a plugin in a contact list.

### BACKGROUND

A contact list is an application used in most communication devices, such as mobile phones, tablet computers, etc. In general, the contact list may be used to store contact information such as names, phone numbers, home addresses, email addresses, and birthdays of contacts. Conventionally, contact lists in mobile devices are usually provided with certain basic common functions. For example, a user can select a contact in a contact list to call the contact's phone number or send a message directly.

However, conventional contact lists may not be able to satisfy requirements of different users. For example, conventional contact lists are based on closed platforms and, thus, if it is desired to add all of the different users' individual requirements to a contact list, the contact list generally needs to be redesigned with a large amount of work. In addition, running stability and response speeds of mobile devices may be decreased due to an excess of program data of the redesigned contact list. Also, functions in the redesigned contact list that are redundant to a user may degrade use experience of that user.

### SUMMARY

According to a first aspect of the present disclosure, there is provided a method for a device to provide a plugin in a contact list, wherein the contact list includes an open interface, and the plugin is generated based on a specification defined according to the open interface, the method comprising: receiving a first request for installing the plugin, and performing an authentication of the plugin according to the first request; adding the plugin into the contact list after the authentication succeeds; and receiving a second request for invoking a function of the plugin, and invoking the function of the plugin according to the second request.

According to a second aspect of the present disclosure, there is provided a device for providing a plugin in a contact list, wherein the contact list includes an open interface, and the plugin is generated based on a specification defined according to the open interface, the device comprising: a processor; and a memory for storing instructions executable by the processor; wherein the processor is configured to: receive a first request for installing the plugin, and perform an authentication of the plugin according to the first request; add the plugin into the contact list after the authentication succeeds; and receive a second request for invoking a function of the plugin, and invoke the function of the plugin according to the second request.

According to a third aspect of the present disclosure, there is provided a non-transitory computer-readable medium having stored therein instructions that, when executed by a processor of a device, cause the device to perform a method for providing a plugin in a contact list, wherein the contact list includes an open interface, and the plugin is generated based on a specification defined according to the open interface, the method comprising: receiving a first request for installing the plugin, and performing an authentication of the plugin according to the first request; adding the plugin into the contact list after the authentication succeeds; and receiving a second request for invoking a function of the plugin, and invoking the function of the plugin according to the second request.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of a method for a device to provide a plugin in a contact list, according to an exemplary embodiment.

FIGS. 2a-2g are schematic diagrams of displays on a device showing plugin display positions on a contact list platform, according to exemplary embodiments.

FIGS. 3-13 are diagrams of displays on a device when the device receives requests for invoking functions of plugins, according to exemplary embodiments.

FIG. 14 is a flowchart of a method for a device to provide a plugin in a contact list, according to an exemplary embodiment.

FIG. 15 is a block diagram of a device for providing a plugin in a contact list, according to an exemplary embodiment.

FIG. 16 is a block diagram of a device for providing a plugin in a contact list, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

In exemplary embodiments, there is provided a method that, by opening an interface of a contact list in a device and importing a third-party application plugin via the interface, enables a user to use a function of the third-party application directly on the contact list via the plugin.

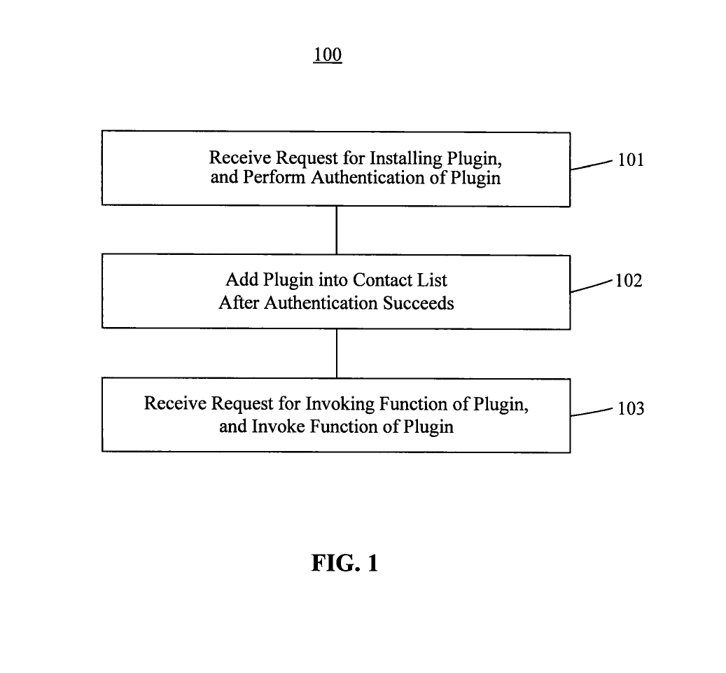

FIG. 1 is a flowchart of a method 100 for a device to provide a plugin in a contact list, according to an exemplary embodiment. For example, the device may be a tablet computer, a personal digital assistant, a mobile phone, etc. In the embodiment, the contact list has an open interface, and the plugin refers to a third-party application plugin which is generated based on a specification defined according to the open interface. Referring to FIG. 1, the method 100 includes the following steps.

In step 101, the device receives a request for installing the plugin, and performs an authentication of the plugin according to the request.

In step 102, the device adds the plugin into the contact list after the authentication succeeds.

In step 103, the device receives a request for invoking a function of the plugin, and invokes the function of the plugin according to the request.

In the present disclosure, the “contact list,” or a “contact list platform” with respect to functions of the open interface to be loaded thereon, refers to a contact list application installed or configured on the device, such as a contact list application on a mobile phone.

In exemplary embodiments, contacts in the contact list may comprise contact information stored in the device, such as names, phone numbers, home addresses, email addresses, and birthdays of the contacts in the contact list that are input by a user. The contacts in the contact list may also comprise contact information stored in a cloud storage, such as contact information submitted by the user to be stored in a cloud server. In one exemplary embodiment, the contact list may also comprise contact information of contacts of bound account numbers. For example, when a Social Network Service (SNS)/Instant Messaging (IM) account number is in the user contact list, the contact list may further comprise contacts of the SNS/IM account numbers. The bound account numbers may also comprise account numbers involving the user's social network such as an account number of a game platform, an account number of online voice/video call service, an account number of a network disk, and an account number of a terminal interconnection service. When contacts of the user's account numbers are not bound, the device performs a temporary account number authorization, that is, verifying those account numbers and corresponding passwords via the contact list, to obtain related account number contact information.

In exemplary embodiments, the open interface of the contact list may include an application programming interface (API) based on an operating system (OS) of the device, such as an OS user interface (UI), common controls, data (e.g., contact data), functions (e.g., merging replicated contacts), and principles corresponding to the above items such as a method for processing polyphonic characters and rules for ranking and grouping contacts.

As noted above, the plugin refers to a third-party application plugin which is generated based on a specification defined according to the open interface of the contact list. In one exemplary embodiment, the specification defined according to the open interface may comprise a UI specification and a predefined authority specification. The UI specification may comprise a specification for codes and controls design. The specification for codes design specifies that codes of the plugin should be in conformity with coding requirements of the device's OS and the contact list's API. The specification for controls design specifies which position(s) are opened and which way of representation is used in the contact list for representing the plugin.

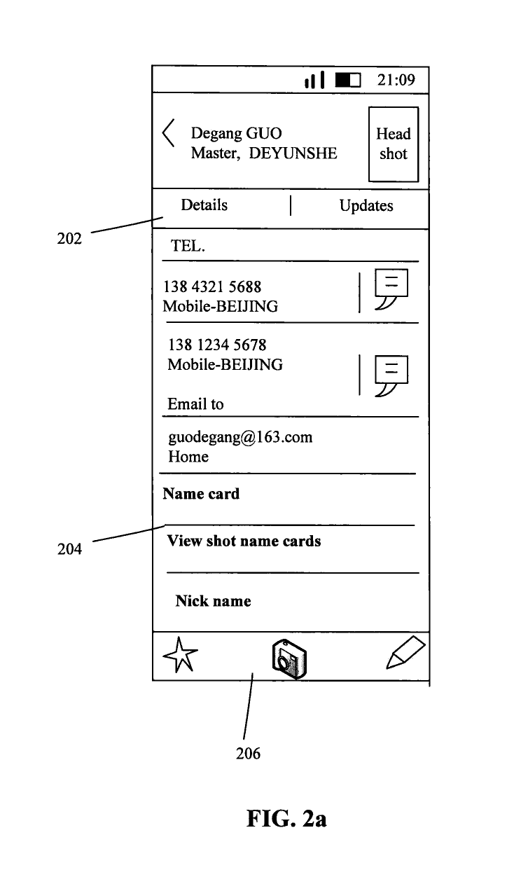

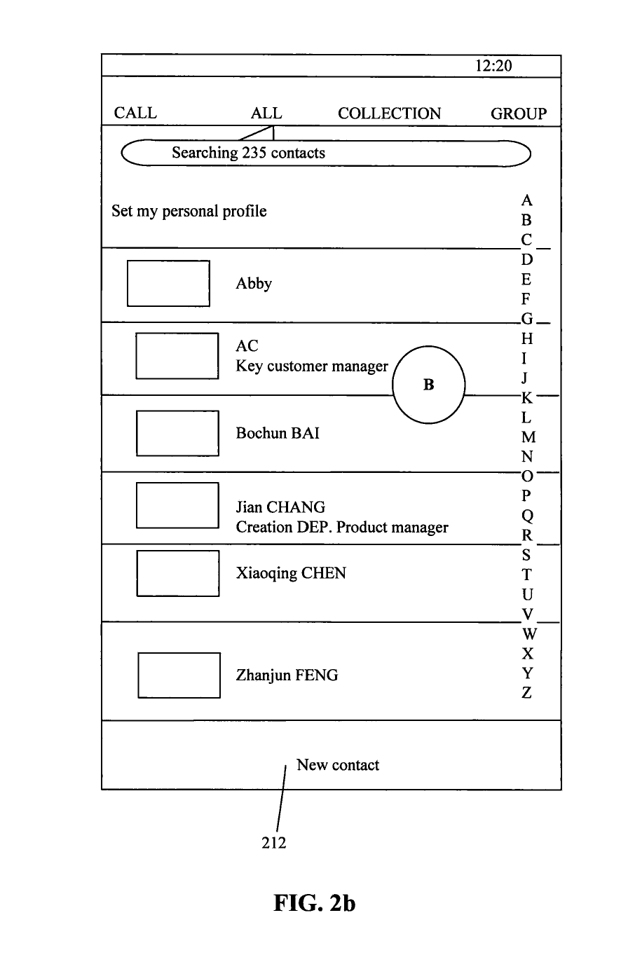

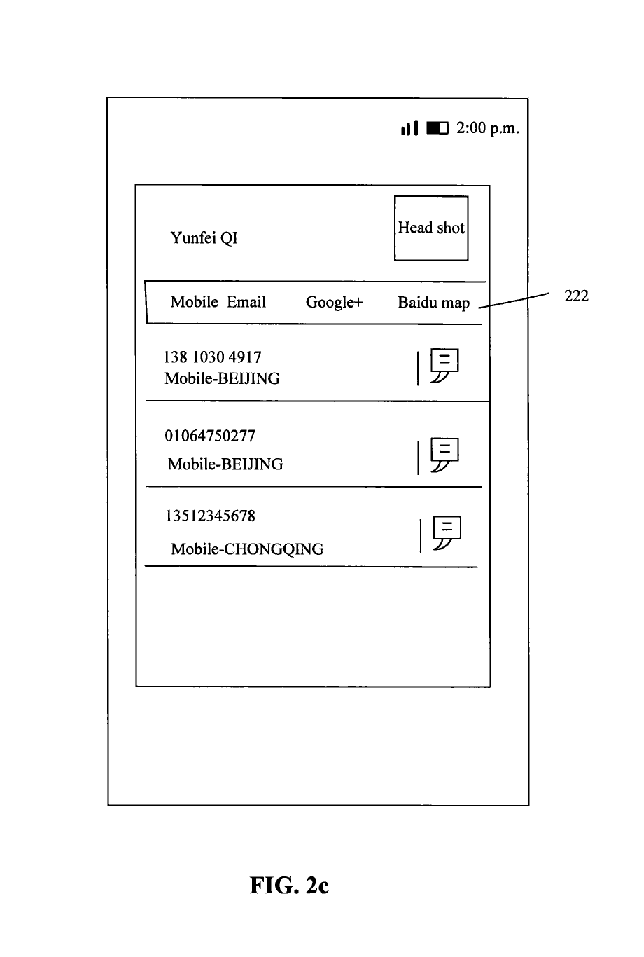

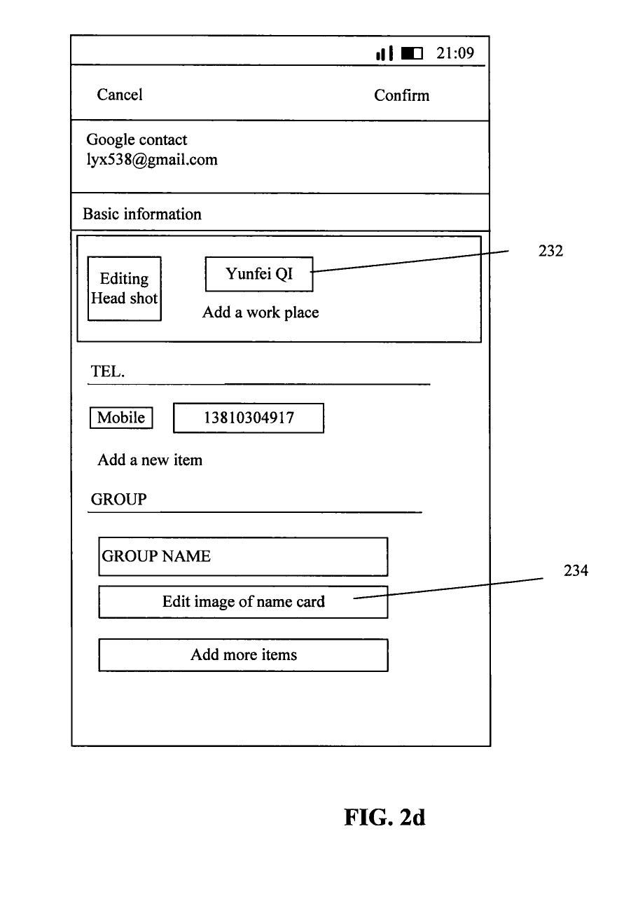

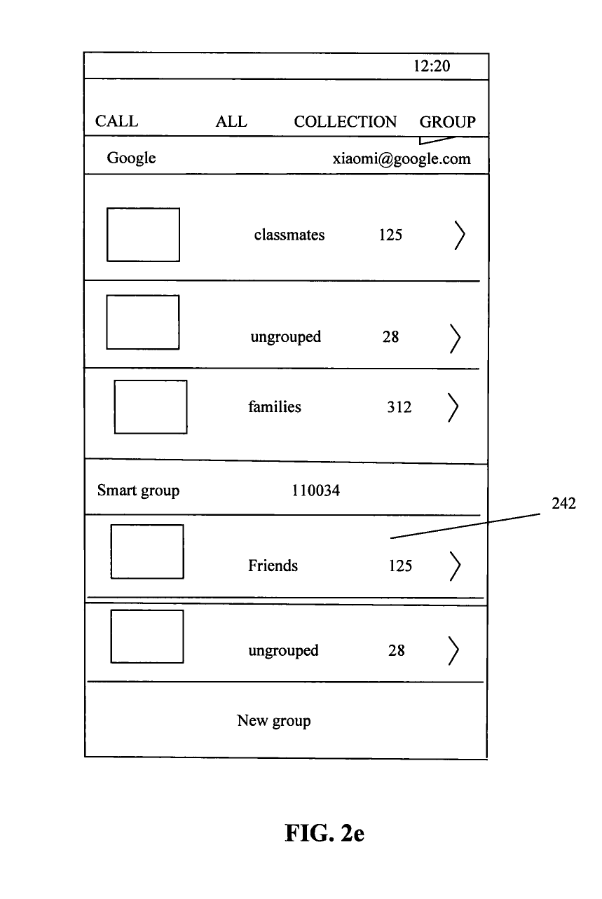

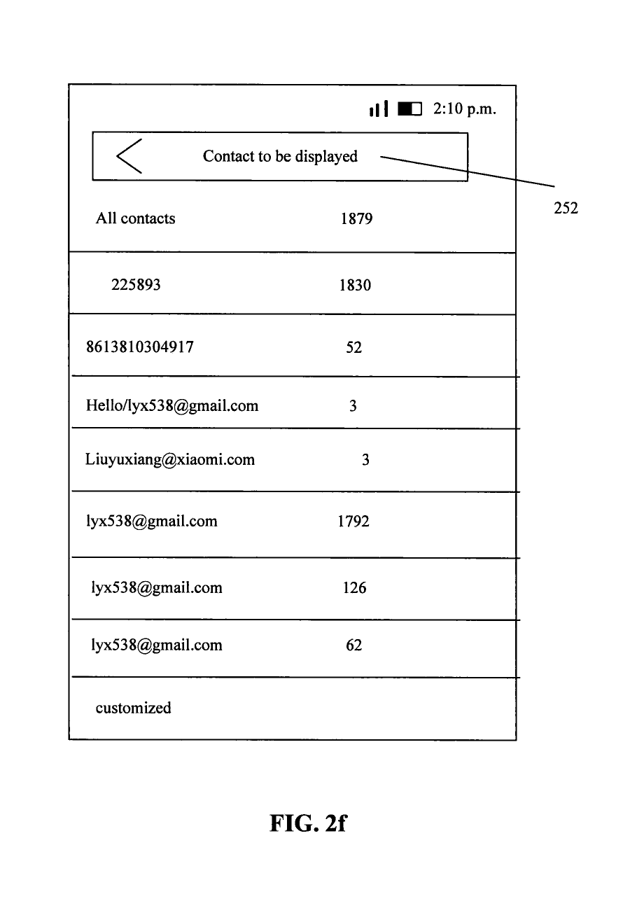

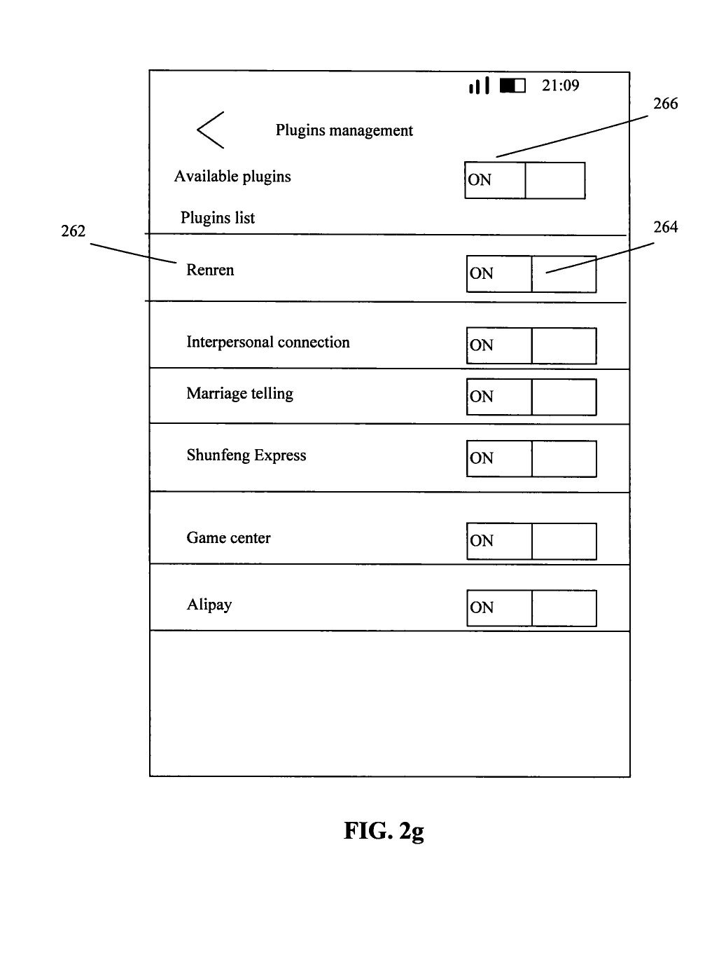

FIGS. 2a-2g are schematic diagrams of displays on a device showing plugin display positions on the contact list platform, according to exemplary embodiments. Referring to FIG. 2a, a TAB field 202, a group field 204, and an action field 206 are open for plugins in a contact information interface of the contact list, each to provide display for a plugin having a relevant function. Referring to FIG. 2b, all contacts in the contact list are displayed on an “ALL” interface of a main interface of the contact list, and in the “ALL” interface an action field 212 is open to provide display for a plugin having a relevant function. Referring to FIG. 2c, a contact may be clicked for viewing a brief introduction on the “ALL” interface of the main interface of the contact list, and in the “All” interface a new tab field 222 is open to provide display for a plugin having a relevant function. Referring to FIG. 2d, an edit box 232 with write permission is open for a plugin to write contact information on a contact information editing interface, and an edit item 234 is open on this interface to provide display for the plugin having a relevant function. Referring to FIG. 2e, all groups of contacts are displayed on a “GROUP” interface of the main interface of the contact list, and in the “GROUP” interface a group creating field 242 is open to provide display for a plugin having a relevant function. Referring to FIG. 2f, an account field 252 is open in an account number management interface of the contact list, to provide display for a plugin having a relevant function. Referring to FIG. 2g, installation information of a plugin 262 as well as a corresponding authority switch 264 may be displayed on a plugin management interface of the contact list, and there may also be an integrated authority switch 266 for all of the plugins, by which the user is able to turn on or off the plugins. In addition, a function of uninstallation management of the plugins may be provided on the plugin management interface of the contact list or may be provided at other positions.

In exemplary embodiments, the predefined authority specification may comprise read and/or write permissions for data of the contact list, read and/or write permissions for data of an associated third-party application, and processing permissions for data of a plugin, but is not so limited.

If a plugin attached to the contact list and a separate application (APP) both can be used to achieve a simple application, the plugin, which is generated based on the specification defined according to the open interface, may occupy less system resources and storage space compared to the separate APP.

In exemplary embodiments, when a request for installing a plugin is received by the contact list platform of the device, the device first performs an authentication of the plugin. The authentication refers to analyzing legality of the plugin for ensuring running security of the contact list so as to, for example, prevent the contact list from being damaged due to installation errors, prevent the plugin from performing malicious applications such as stealing user data illegally and issuing service instructions illegally.

In exemplary embodiments, authorities of a plugin may be established by first and second manners.

In the first manner, a developer of the plugin may prearrange for an authorization with a developer of the contact list, so as to verify the plugin by means of a fixed identification (ID) or a key verification via cloud.

In the second manner, verification is performed by a user, in which an authority switch of the plugin may be displayed in the contact list after a request for installation is sent from the plugin, and the switch may be turned on or off by the user.

Referring back to FIG. 1, in one exemplary embodiment, the method 100 applies the first manner in step 101. Accordingly, the authentication to verify legality of the plugin may be performed quickly without additional analysis, thereby providing easy installation and legality warrant. The second manner is suitable for plugin management, considering that not all plugins are applicable to different contacts when multiple plugins are installed in the contact list. Accordingly, the contact information interface may be kept neat, and the contact list may have reduced burden in operation by controlling respective authority switches of the plugins.

In one exemplary embodiment, step 101 of the method 100 may further include the following substeps.

In substep S11, the device receives the request for installing the plugin, and determines whether the plugin conforms to the User Interface (UI) specification and the predefined authority specification and, if so, performs substep S12; otherwise, the device performs substep S13.

In substep S12, the device determines that the authentication succeeds.

In substep S13, the device generates a prompt message to prompt the user to determine whether to continue the installation.

The first manner in which the developer of the contact list prearranges for the authorization with the developer of the plugin and then the verification is performed by means of a fixed ID, or a key verification via cloud may also be applicable in the substep S11. When the authority of the plugin exceeds a specified scope defined according to the interface, the user can judge legality of the plugin according to the prompt message and determines whether to install the plugin. After the authentication succeeds, the plugin may be added into the contact list platform.

In one exemplary embodiment, step 102 of the method 100 may further include the following substeps.

In substep S21, the device presents the plugin at a corresponding position of the contact list in a designated mode based on the specification defined according to the interface.

In substep S22, the device installs a functional data packet carried in the plugin. The functional data packet comprises substantive content of the plugin. Depending on different functional data packets, the plugin may perform data reading and/or writing between the contact list and the third-party application, or may perform simple applications.

For example, the device may import a plugin with a function of birthday reminder into the contact list platform, for reminding the user about birthdays of the contacts in the contact list. Herein, contact list data includes the contacts and their birthdays. The plugin generates a button for the function of birthday reminder on the contact information interface, determines a target contact, a reminding time period, and a reminding manner according to user selections, and then invokes the plugin to perform the corresponding function of reminder.

In one exemplary embodiment, step 103 of the method 100 may further include the following substeps.

In substep S31, the device receives the request for invoking the function of the plugin from the user, opens the functional data packet carried in the plugin, and opens an entry to a third-party application associated with the plugin through the functional data packet.

In substep S32, the device provides data from the contact list to the third-party application via the entry, and performs the function in the third-party application.

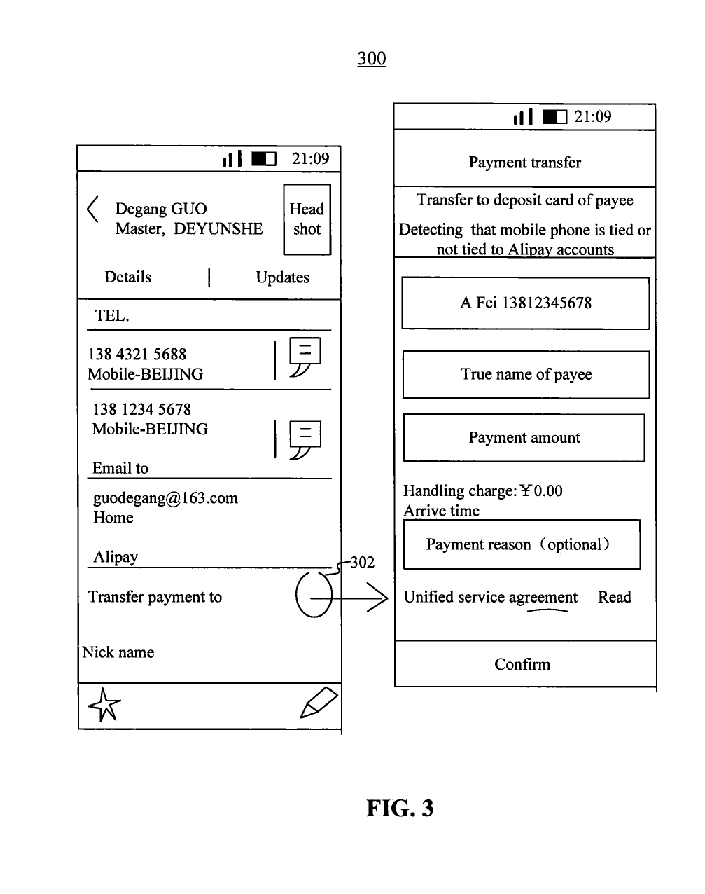

FIG. 3 is a diagram of a sequence of displays 300 on the device when the device receives a request for invoking a function of a plugin, according to an exemplary embodiment. Referring to FIG. 3, in the illustrated embodiment, the plugin is a plugin for transferring a payment to a target contact in the contact list.

In one exemplary embodiment, the device receives a request, e.g., through a click 302, from the user for transferring a payment to the target contact, and opens an entry to a third-party application associated with the plugin according to the received request. The device further provides data of the target contact and the user to the third-party application via the entry, and performs the function of payment transfer in the third-party application.

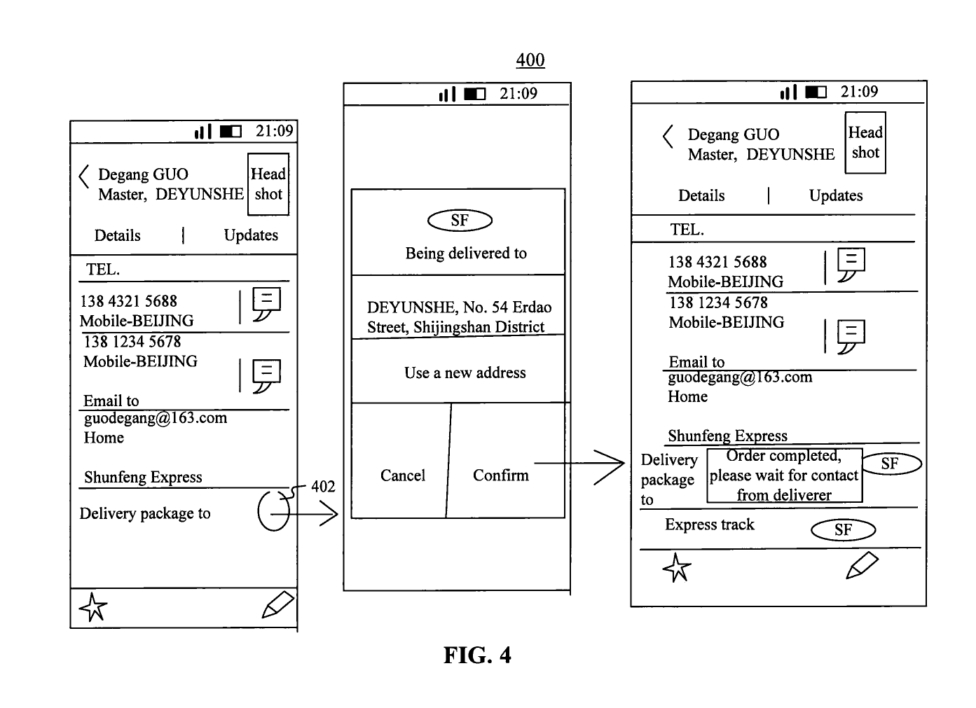

FIG. 4 is a diagram of a sequence of displays 400 on the device when the device receives the request for invoking the function of the plugin, according to an exemplary embodiment. Referring to FIG. 4, in the illustrated embodiment, the plugin is a plugin for delivering a package to a target contact in the contact list.

In one exemplary embodiment, the device receives a request, e.g., through a click 402, from the user for delivering a package to the target contact, and opens an entry to a third-party application associated with the plugin according to the received request. The device further provides data of the target contact and the user to the third-party application via the entry, for the third-party application to send the data of the user and the target contact to a delivery company.

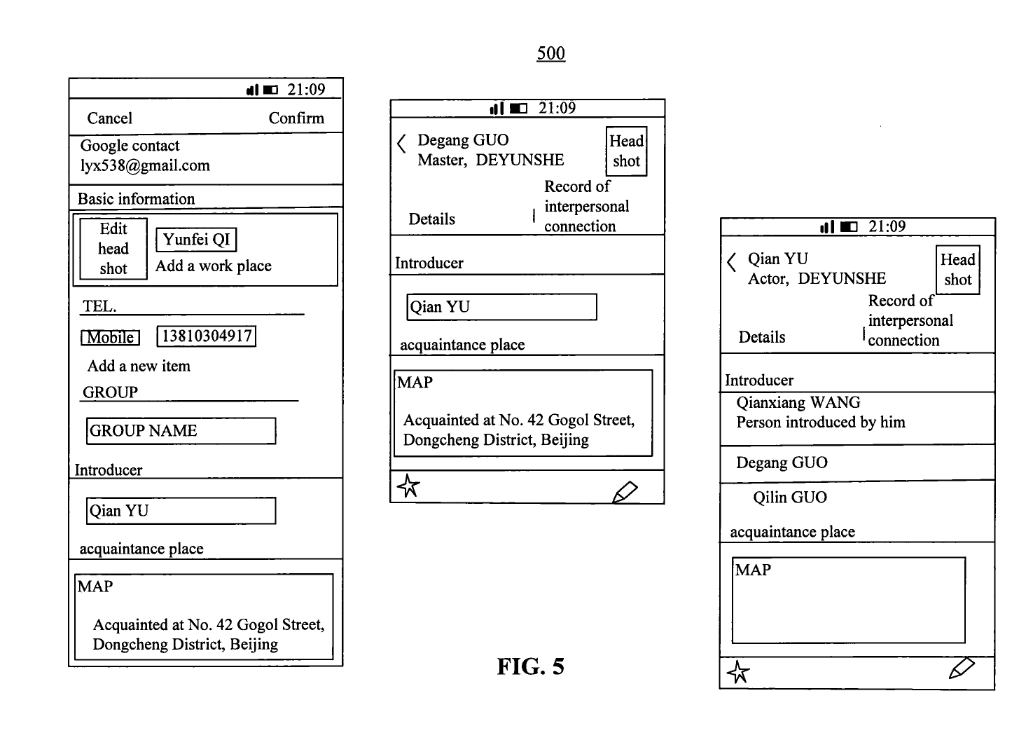

FIG. 5 is a diagram of a sequence of displays 500 on the device when the device receives a request for invoking a function of a plugin, according to an exemplary embodiment. Referring to FIG. 5, in the illustrated embodiment, the plugin is a plugin for adding interpersonal connections to a target contact in the contact list.

In one exemplary embodiment, the device receives a request from the user for adding interpersonal connections to the target contact, and opens an entry to a third-party application associated with the plugin. The device further writes data feedback from the third-party application into information of the target contact, and the plugin writes data of the interpersonal connections into information of contacts related to the interpersonal connections.

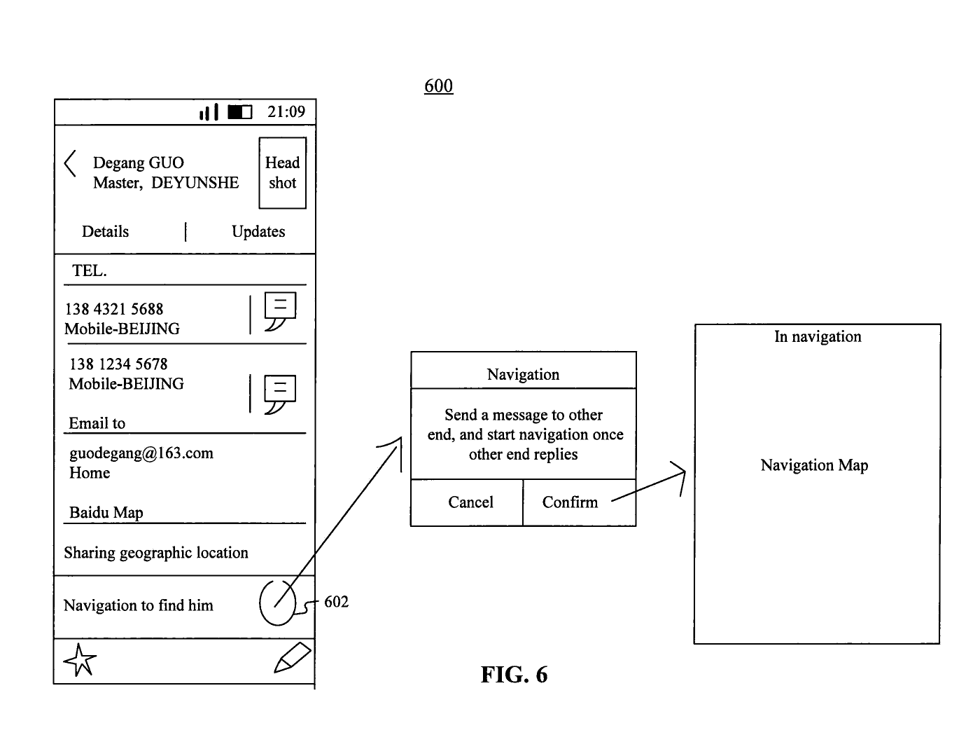

FIG. 6 is a diagram of a sequence of displays 600 on the device when the device receives a request for invoking a function of a plugin, according to an exemplary embodiment. Referring to FIG. 6, in the illustrated embodiment, the plugin is a plugin for inquiring a geographic location of a target contact in the contact list.

In one exemplary embodiment, the device receives a request, e.g., through a click 602, from the user for inquiring a geographic location of the target contact, sends designated information to the target contact according to the received request. and opens an entry to a third-party application associated with the plugin. The device further provides data of the user and data responded from the target contact to the third-party application via the entry, and performs the function of location inquiry in the third-party application.

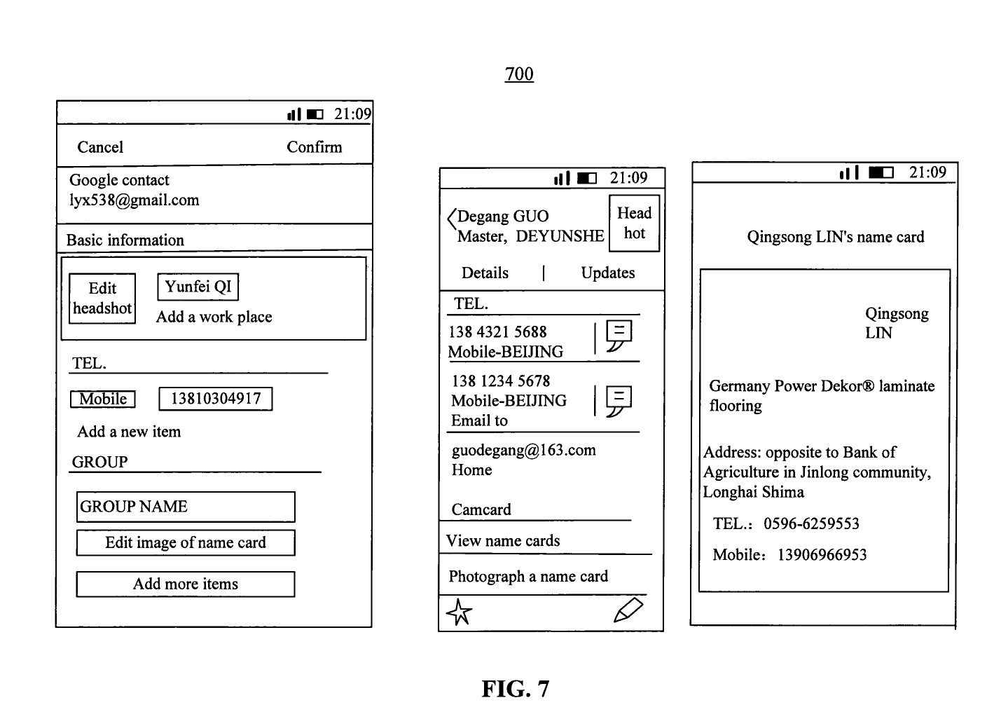

FIG. 7 is a diagram of a sequence of displays 700 on the device when the device receives a request for invoking a function of a plugin, according to an exemplary embodiment. Referring to FIG. 7, in the illustrated embodiment, the plugin is a plugin for inquiring a name card of a target contact in the contact list.

In one exemplary embodiment, the device receives a request from the user for inquiring a name card of the target contact, and opens an entry to a third-party application associated with the plugin according to the received request. The device further provides data of the target contact to the third-party application via the entry, and performs the function of inquiring the name card in the third-party application.

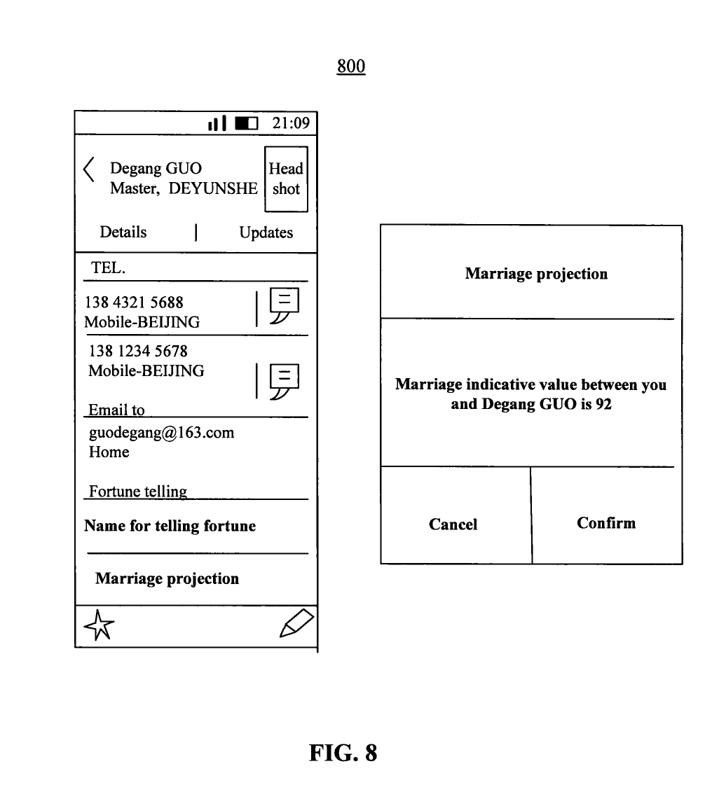

FIG. 8 is a diagram of a sequence of displays 800 on the device when the device receives a request for invoking a function of a plugin, according to an exemplary embodiment. Referring to FIG. 8, in the illustrated embodiment, the plugin is a plugin for entertainment.

In one exemplary embodiment, the device receives a request from the user for telling the fortune of a target contact in the contact list, and opens an entry to a third-party application associated with the plugin according to the received request. The device further provides data of the target contact and the user to the third-party application via the entry, and performs the function of fortune telling in the third-party application.

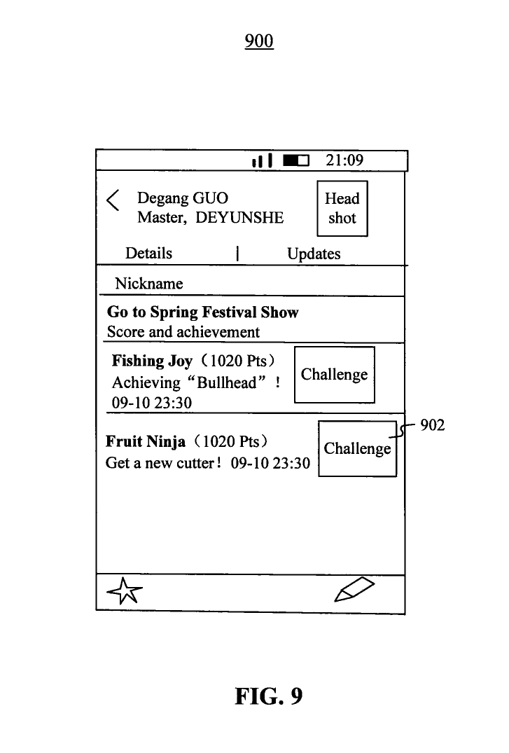

FIG. 9 is a diagram of a display 900 on the device when the device receives a request for invoking a function of a plugin, according to an exemplary embodiment. Referring to FIG. 9, in the illustrated embodiment, the plugin is a plugin for a game center.

In one exemplary embodiment, through the plugin, the device adds account information of a target contact in the contact list into contact information of the target contact. The device receives a request, e.g., through a click 902, from the user for playing a game with the target contact, and opens an entry to a third-party application associated with the plugin according to the received request. The device further provides data of the target contact and the user to the third-party application via the entry, and performs the function of game playing in the third-party application.

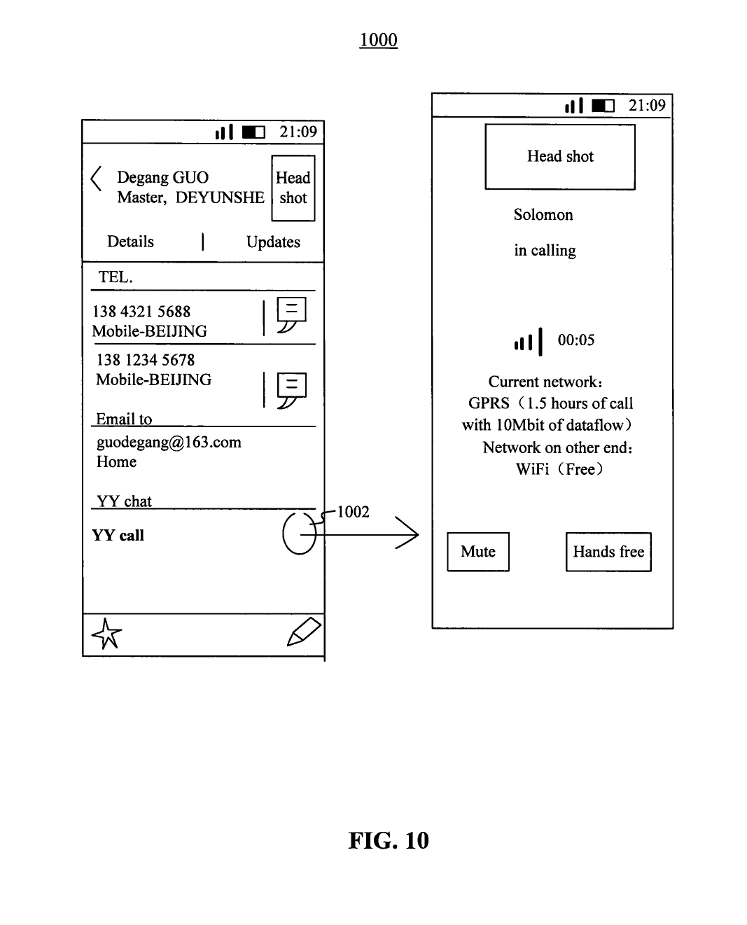

FIG. 10 is a diagram of a sequence of displays 1000 on the device when the device receives a request for invoking a function of a plugin, according to an exemplary embodiment. Referring to FIG. 10, in the illustrated embodiment, the plugin is a plugin for an online voice/video call with a target contact in the contact list.

In one exemplary embodiment, through the plugin, the device adds account information of the target contact for an online voice/video call service into contact information of the target contact, and may determine whether the target contact is on line according to an online status. The device receives a request, e.g., through a click 1002, from the user for an online voice/video call with the target contact, and opens an entry to a third-party application associated with the plugin according to the received request. The device further provides data of the target contact and the user to the third-party application via the entry, and performs the function of online voice/video call in the third-party application.

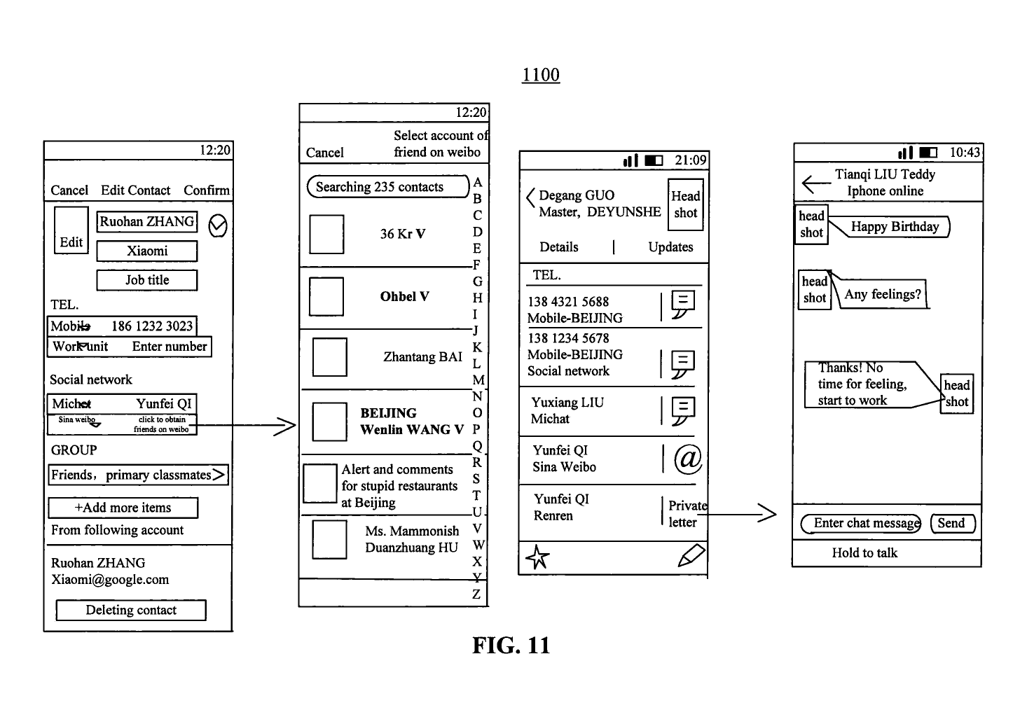

FIG. 11 is a diagram of a sequence of displays 1100 on the device when the device receives a request for invoking a function of a plugin, according to an exemplary embodiment. Referring to FIG. 11, in the illustrated embodiment, the plugin is a plugin for instant chat with a target contact in the contact list.

In one exemplary embodiment, through the plugin, the device adds account information for the target contact for an instant chat service into contact information of the target contact, and may determine whether the target contact is on line according to an online status. The device receives a request submitted by the user for instant chat with the target contact, and opens an entry to a third-party application associated with the plugin for instant chat according to the received request. The device further provides data of the target contact and the user to the third-party application via the entry, and performs the function of instant chat in the third-party application.

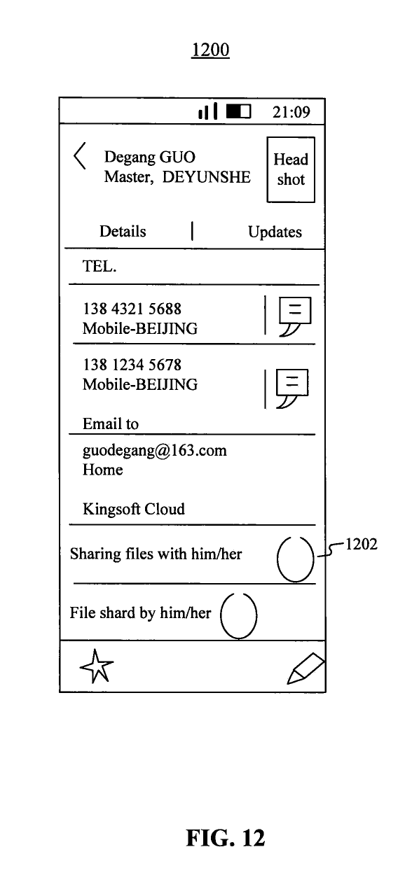

FIG. 12 is a diagram of a display 1200 on the device when the device receives a request for invoking a function of a plugin, according to an exemplary embodiment. Referring to FIG. 12, in the illustrated embodiment, the plugin is a plugin for sharing files with a target contact in the contact list.

In one exemplary embodiment, through the plugin, the device adds account information of the target contact for a network storage service into contact information of the target contact. The device receives a request, e.g., through a click 1202, from the user for sharing files with the target contact, and opens an entry to a third-party application associated with the plugin according to the received request. The device further provides data of the target contact and the user to the third-party application via the entry, and performs the function of sharing files in the third-party application.

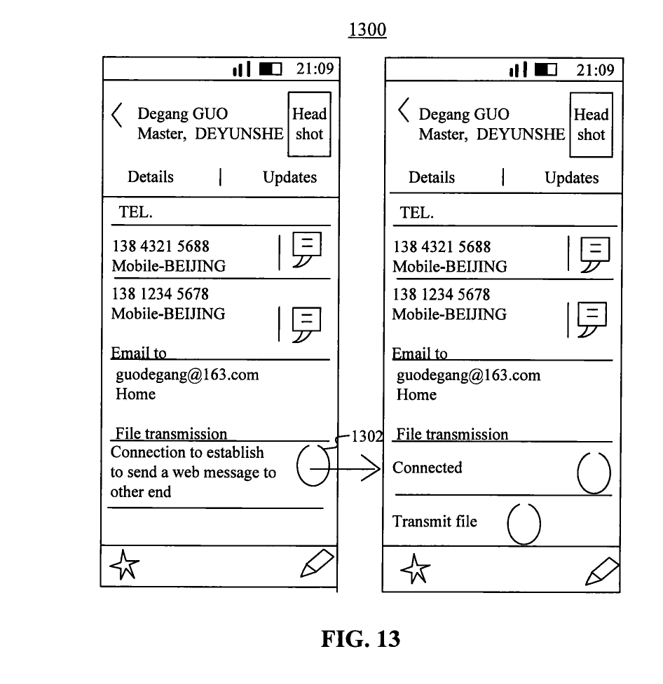

FIG. 13 is a diagram of a sequence of displays 1300 on the device when the device receives a request for invoking a function of a plugin, according to an exemplary embodiment. Referring to FIG. 13, in the illustrated embodiment, the plugin is a plugin for device interconnection with a target contact in the contact list.

In one exemplary embodiment, through the plugin, the device adds account information of the target contact for a device interconnection service into contact information of the target contact. The device receives a request, e.g., through a click 1302, from the user for interconnecting with a device of the target contact, and opens an entry to a third-party application associated with the plugin according to the received request of the user. The device further provides data of the target contact and the user to the third-party application via the entry, and performs the function of device interconnection in the third-party application.

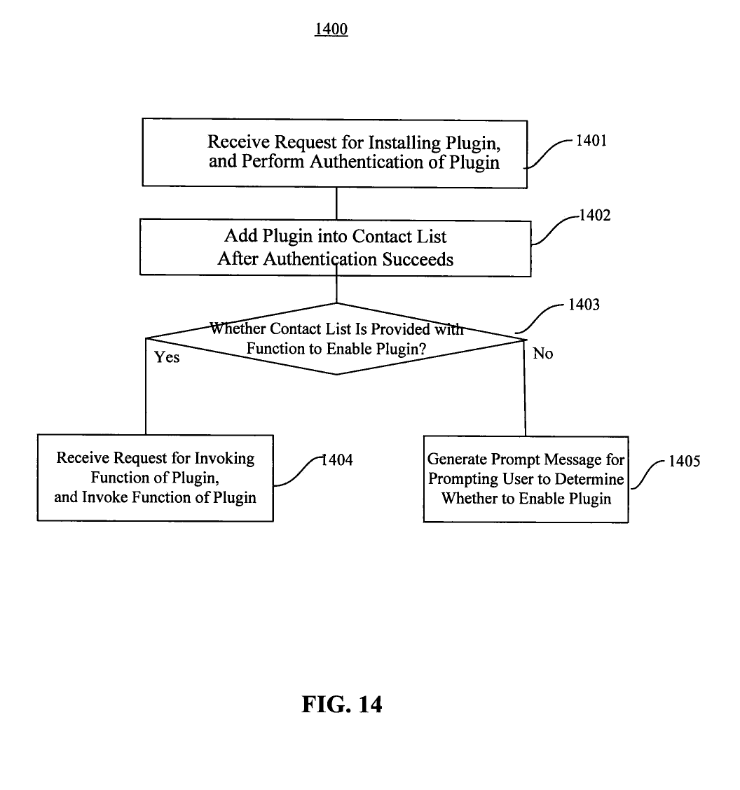

FIG. 14 is a flowchart of a method 1400 for a device to add a plugin into a contact list, according to an exemplary embodiment. Referring to FIG. 14, the method 1400 includes the following steps.

In step 1401, the device receives a request for installing a plugin, and performs an authentication of the plugin according to the request.

In step 1402, the device adds the plugin into the contact list after the authentication succeeds.

In step 1403, the device determines whether the contact list is provided with a function to enable the plugin and, if so, performs step 1404; otherwise, the device performs step 1405.

In step 1404, the device receives a request for invoking a function of the plugin, and invokes the function of the plugin according to the request.

In step 1405, the device generates a prompt message for prompting the user to determine whether to enable the plugin.

In the illustrated embodiment, it is determined whether the contact list is provided with the function to enable the plugin before receiving the request for invoking the function of the plugin. Depending on different design concepts of plugins, a plugin may be enabled or disabled by default after its installation, or a user may re-enable a plugin as desired after disabling the same. The plugin may also be disabled due to other situations. By adopting this solution, it may be determined in advance whether the contact list is provided with the function to enable the plugin, and then a user may choose to enable the plugin when in need and disable the plugin when not in need, thus saving resources and improving user experiences.

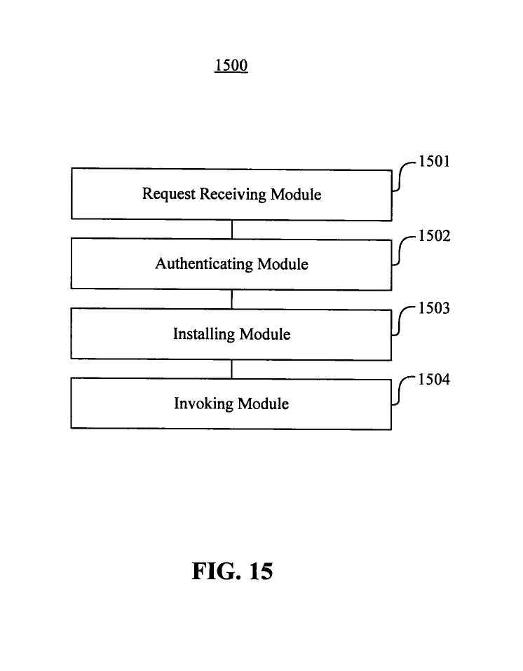

FIG. 15 is a block diagram of a device 1500 for adding a plugin into a contact list, according to an exemplary embodiment. Referring to FIG. 15, the device 1500 includes a request receiving module 1501 configured to receive a request for installing the plugin, an authenticating module 1502 configured to perform an authentication of the plugin according to the request, an adding module 1503 configured to add the plugin into the contact list after the authentication succeeds, and an invoking module 1504 configured to receive a request for invoking a function of the plugin, and invoke the function of the plugin according to the request.

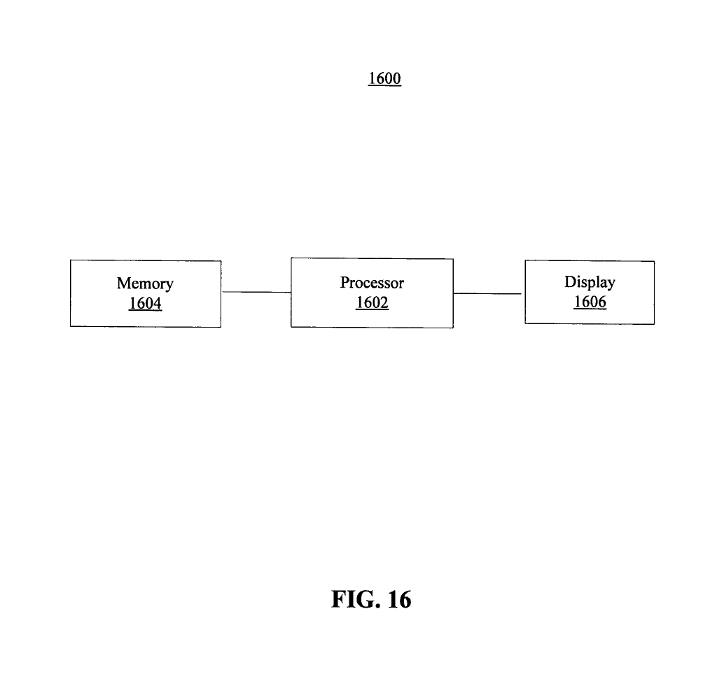

FIG. 16 is a block diagram of a device 1600 for adding a plugin into a contact list, according to an exemplary embodiment. Referring to FIG. 16, the device 1600 includes a processor 1602 configured to execute program instructions to perform the above described methods for adding a plugin into a contact list, a memory 1604 configured to store information and program instructions and otherwise facilitate operation of the processor 1602, and a display 1606 configured to display related information when a function of the plugin is invoked according to, e.g., the embodiments in connection with FIGS. 3-13.

In exemplary embodiments, there is also provided a non-transitory computer-readable medium including instructions, such as included in the memory 1604, executable by the processor 1602 in the device 1600, for performing the above described methods for adding a plugin into a contact list.

One of ordinary skill in the art will understand that the above described modules can each be implemented by hardware, or software, or a combination of hardware and software. One of ordinary skill in the art will also understand that multiple ones of the above described modules may be combined as one module, and each of the above described modules may be further divided into a plurality of sub-modules.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for a device to provide a plugin in a contact list, wherein the contact list includes an open interface, and the plugin is generated based on a specification defined according to the open interface, the method comprising:
receiving a first request for installing the plugin, and performing an authentication of the plugin according to the first request;
adding the plugin into the contact list after the authentication succeeds; and
receiving a second request for invoking a function of the plugin, and invoking the function of the plugin according to the second request.

2. The method according to claim 1, wherein the specification defined according to the open interface comprises a User Interface (UI) specification and a predefined authority specification.

3. The method according to claim 2, further comprising:
determining, according to the first request, whether the plugin conforms to the UI specification and the predefined authority specification;
if it is determined that the plugin conforms to the UI specification and the predefined authority specification, determining that the authentication succeeds, and
if it is determined that the plugin does not conform to the UI specification or the predefined authority specification, generating a prompt message for prompting a user to determine whether to perform installation of the plugin.

4. The method according to claim 1, wherein the adding of the plugin into the contact list comprises:
presenting the plugin at a corresponding position of the contact list in a designated mode based on the defined specification; and
installing a functional data packet carried in the plugin.

5. The method according to claim 1, further comprising:
determining whether the contact list is provided with a function to enable the plugin;
if it is determined that the contact list is provided with a function to enable the plugin, performing the receiving of the second request for invoking the function of the plugin; and
if it is determined that the contact list is not provided with a function to enable the plugin, generating a prompt message for prompting a user to determine whether to enable the plugin.

6. The method according to claim 4, further comprising:
in response to receiving the second request for invoking the function of the plugin, opening the functional data packet carried in the plugin, and opening an entry to a third-party application associated with the plugin through the functional data packet; and
providing data from the contact list to the third-party application via the entry, and performing the function in the third-party application.

7. The method according to claim 1, wherein the contact list comprises contact information of contacts of bound account numbers in the contact list.

8. A device for providing a plugin in a contact list, wherein the contact list includes an open interface, and the plugin is generated based on a specification defined according to the open interface, the device comprising:
a processor; and
a memory for storing instructions executable by the processor;
wherein the processor is configured to:
receive a first request for installing the plugin, and perform an authentication of the plugin according to the first request;
add the plugin into the contact list after the authentication succeeds; and
receive a second request for invoking a function of the plugin, and invoke the function of the plugin according to the second request.

9. The device according to claim 8, wherein the specification defined according to the open interface comprises a User Interface (UI) specification and a predefined authority specification, the processor being further configured to:
determine, according to the first request, whether the plugin conforms to the UI specification and the predefined authority specification;
if it is determined that the plugin conforms to the UI specification and the predefined authority specification, determine that the authentication succeeds, and
if it is determined that the plugin does not conform to the UI specification or the predefined authority specification, generate a prompt message for prompting a user to determine whether to perform installation of the plugin.

10. The device according to claim 8, the processor being further configured to:
present the plugin at a corresponding position of the contact list in a designated mode based on the defined specification; and
install a functional data packet carried in the plugin.

11. The device according to claim 8, the processor being further configured to:
determine whether the contact list is provided with a function to enable the plugin;
if it is determined that the contact list is provided with a function to enable the plugin, perform the receiving of the second request for invoking the function of the plugin; and
if it is determined that the contact list is not provided with a function to enable the plugin, generate a prompt message for prompting a user to determine whether to enable the plugin.

12. The device according to claim 10, the processor being further configured to:
in response to receiving the second request for invoking the function of the plugin, open the functional data packet carried in the plugin, and open an entry to a third-party application associated with the plugin through the functional data packet; and
provide data from the contact list to the third-party application via the entry, and perform the function in the third-party application.

13. A non-transitory computer-readable medium having stored therein instructions that, when executed by a processor of a device, cause the device to perform a method for providing a plugin in a contact list, wherein the contact list includes an open interface, and the plugin is generated based on a specification defined according to the open interface, the method comprising:
receiving a first request for installing the plugin, and performing an authentication of the plugin according to the first request;
adding the plugin into the contact list after the authentication succeeds; and
receiving a second request for invoking a function of the plugin, and invoking the function of the plugin according to the second request.

14. The non-transitory computer-readable medium according to claim 13, wherein the specification defined according to the open interface comprises a User Interface (UI) specification and a predefined authority specification.

15. The non-transitory computer-readable medium according to claim 14, the method further comprising:
determining, according to the first request, whether the plugin conforms to the UI specification and the predefined authority specification;
if it is determined that the plugin conforms to the UI specification and the predefined authority specification, determining that the authentication succeeds, and
if it is determined that the plugin does not conform to the UI specification or the predefined authority specification, generating a prompt message for prompting a user to determine whether to perform installation of the plugin.

16. The non-transitory computer-readable medium according to claim 13, wherein the adding of the plugin into the contact list comprises:
presenting the plugin at a corresponding position of the contact list in a designated mode based on the defined specification; and
installing a functional data packet carried in the plugin.

17. The non-transitory computer-readable medium according to claim 13, the method further comprising:
determining whether the contact list is provided with a function to enable the plugin;
if it is determined that the contact list is provided with a function to enable the plugin, performing the receiving of the second request for invoking the function of the plugin; and
if it is determined that the contact list is not provided with a function to enable the plugin, generating a prompt message for prompting a user to determine whether to enable the plugin.

18. The non-transitory computer-readable medium according to claim 16, the method further comprising:
in response to receiving the second request for invoking the function of the plugin, opening the functional data packet carried in the plugin, and opening an entry to a third-party application associated with the plugin through the functional data packet; and
providing data from the contact list to the third-party application via the entry, and performing the function in the third-party application.
